(19) United States
(12) Patent Application Publication
(10) Pub. No.: US 2017/0055317 A1
(43) Pub. Date: Feb. 23, 2017

(54) HEATER

(71) Applicant: ROHM CO., LTD., KYOTO (JP)

(72) Inventor: YASUYUKI ARITAKI, KYOTO (JP)

(21) Appl. No.: 15/231,466

(22) Filed: Aug. 8, 2016

(30) Foreign Application Priority Data
Aug. 21, 2015 (JP) 2015-163981

(51) Int. Cl. H05B 3/26; G03G 15/20; H05B 3/14

(52) U.S. Cl. CPC H05B 3/26; H05B 3/141; G03G 15/2053; H05B 2203/007

(57) ABSTRACT

The present invention provides a heater capable of prohibiting failures of a substrate and a heat resistor. The heater of the present invention includes a substrate in a longitudinal shape, a heat resistor formed on the substrate, and an electrode for resistor formed on the substrate and connected to the heat resistor. The heat resistor includes a first elongated portion, and the first elongated portion extends along a long side direction of the substrate and is disposed in a side in a first short side direction, which is one of short side directions of the substrate. A ratio of a distance between the first elongated portion and an edge of the substrate on the first short side direction, to a thickness of the substrate is more than 0 and less than 1.75.

### BACKGROUND

The present invention is related to a heater.

heater has been known for a toner fixed in an office automation apparatus (for example, an electronic copier, a facsimile machine and a printer). Such heater includes a longitudinal shaped substrate and a heat-generating resistor, for example. In this heater, if the heating component of resistor generates heat, the substrate and the resistor heating component generate thermal stress. In the conventional heaters, there is a poor situation that the substrate and the heating component fails due to the thermal stress. As the literature regarding the heater, the patent literature 1 is well-known.

### BACKGROUND TECHNICAL LITERATURES

### Patent Literatures

[Patent literature 1] Japanese Patent Application Publication No. 2009-193844

### BRIEF SUMMARY OF THE INVENTION

### Problems to be Solved in the Invention

The present invention is carried out based on the above situation, and provides a heater for preventing a substrate and a heat resistor from being damaged.

### Technical Means for Solving Problems

In the preferred embodiment of the present invention, the characteristics of the heater provided by the present invention include a longitudinal-shaped substrate; a heat resistor, formed on the substrate; and an electrode for resistor formed on the substrate and in contact with the heat resistor, wherein the heat resistor includes a first elongated portion, the first elongated portion extends along a long side direction of the substrate and is disposed in one of short side directions of the substrate, i.e. a first short side direction, and a ratio of a distance between the first elongated portion and an edge of the substrate in the first short side direction to a thickness of the substrate is more than 0 and less than 1.75.

### Effects of the Invention

According to the present invention, the damage to the substrate and the heat resistor can be prevented.

Other features and advantages of the present invention are better understood in the following detailed descriptions with reference to figures.

### BRIEF DESCRIPTION OF THE DRAWINGS

FIG. 1 is a cross-sectional view showing a device according to the first embodiment of the present invention.

FIG. 2 is a top view showing a heater according to the first embodiment of the present invention.

FIG. 3 is a top view showing a main portion of the heater according to the first embodiment of the present invention.

FIG. 4 is a cross-sectional view along the line IV-IV of FIG. 2.

FIG. 5 is an enlarged cross-sectional view showing the main portion of the heater according to the first embodiment of the present invention.

FIG. 6 is an enlarged cross-sectional view showing the main portion of the heater according to the first embodiment of the present invention.

FIG. 7 is a cross-sectional view showing the main portion along the line VII-VII of FIG. 2.

FIG. 8 is a curve diagram showing the relationship between the distance from the heat resistor to an end of the substrate and the endurance time.

FIG. 9 is a curve diagram showing the relationship between the distance from a first elongated portion to a second elongated portion and the endurance time.

FIG. 10 is a top view showing a main portion of a heater according to the second embodiment of the present invention.

FIG. 11 is a cross-sectional view along the line XI-XI of FIG. 10.

### DETAILED DESCRIPTION

In the following descriptions, the preferred embodiments of the present invention are specifically illustrated with reference to the accompanying drawings.

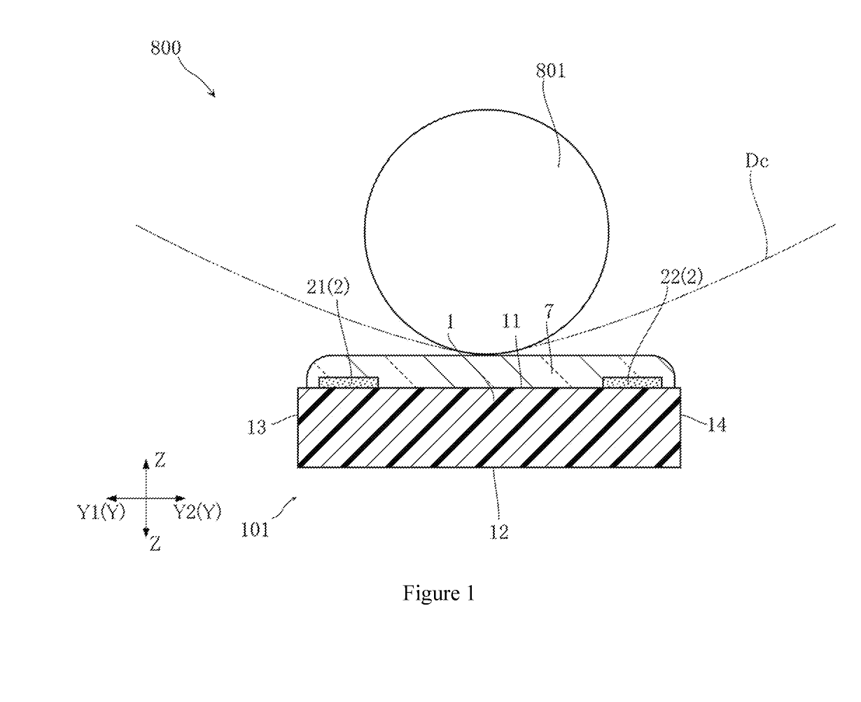

FIG. 1 is a cross-sectional view showing a device according to the first embodiment of the present invention.

A device 800 shown in the figure is, for example, used for toner fixing in an OA (Office Automation) apparatus (for example, an electronic copier, a facsimile machine or a printer). The device 800 includes a heater 101, a platen roller 801 and a thermistor 861.

The heater 101 is opposite to the platen roller 801 for allowing the toner, which is transferred to the heated medium Dc, to be thermally fixed to the heated medium Dc.

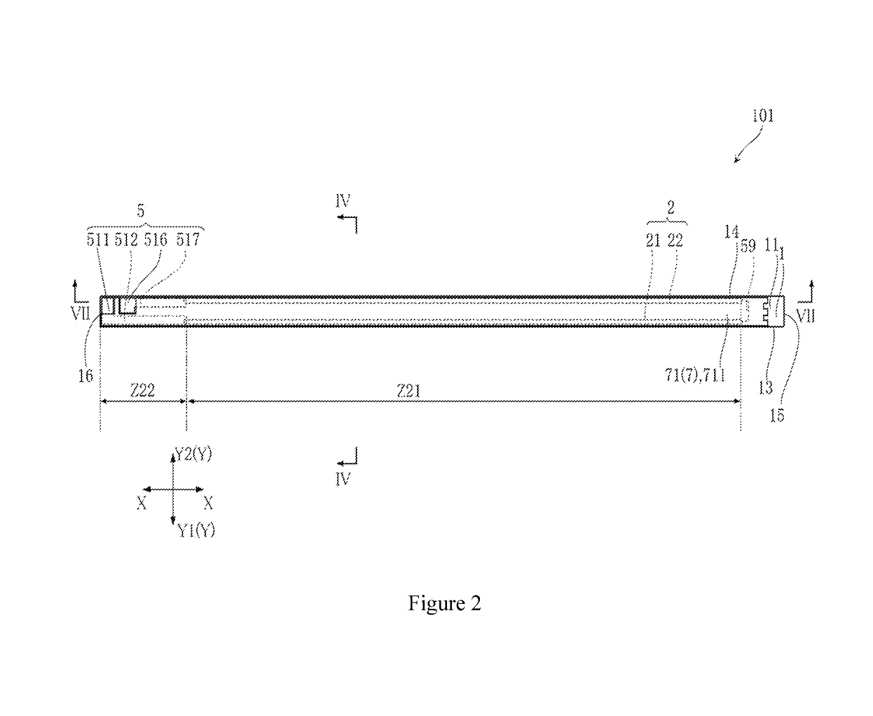

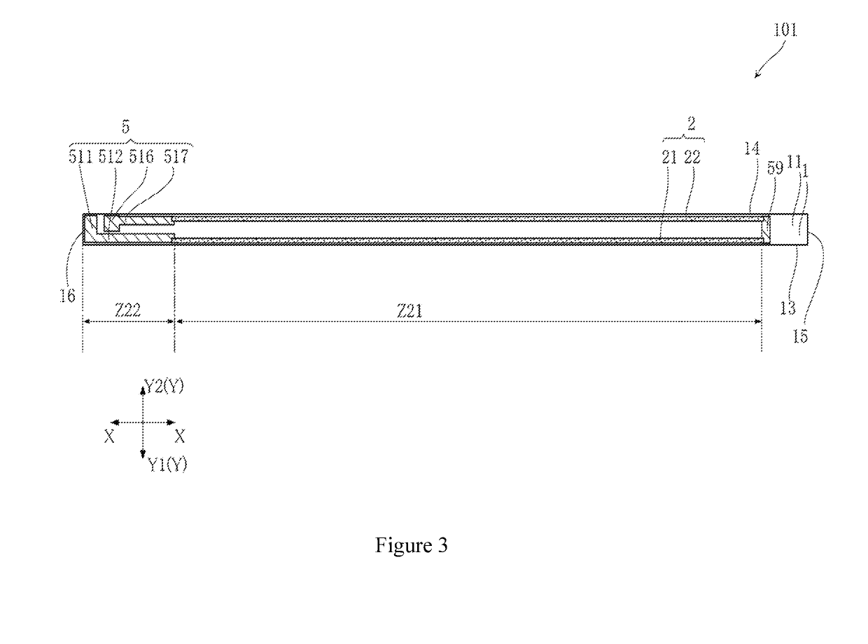

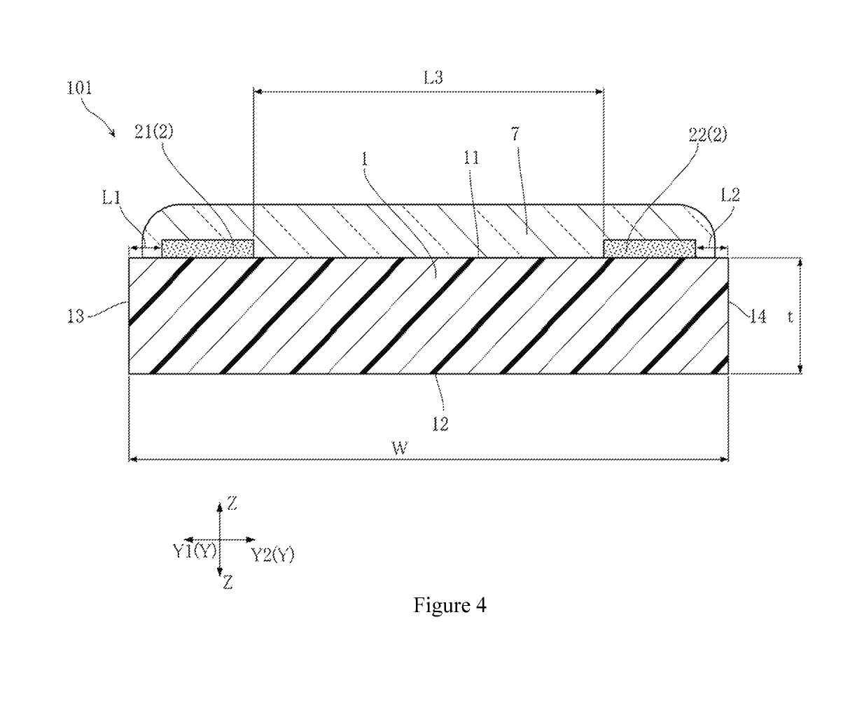

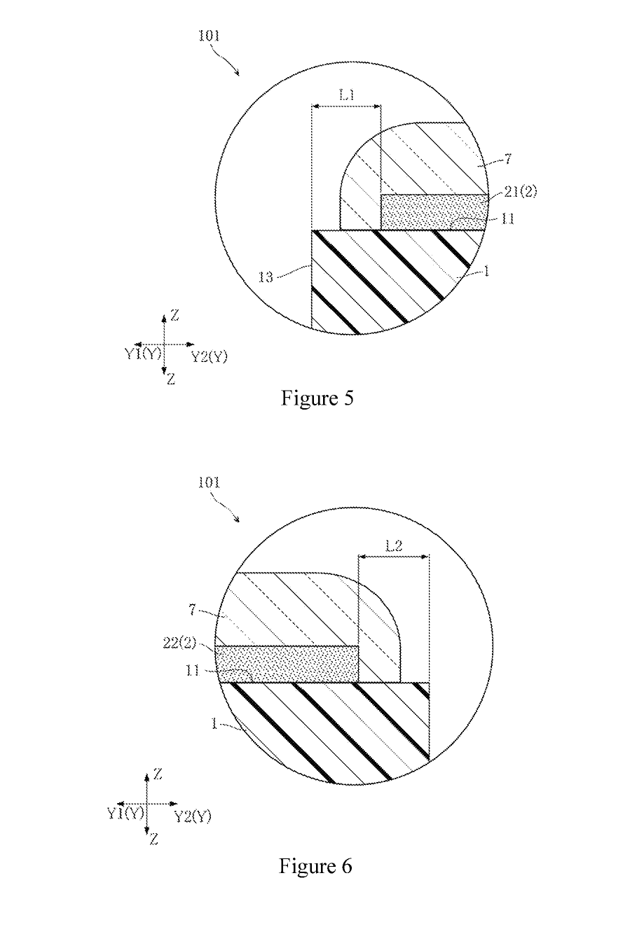

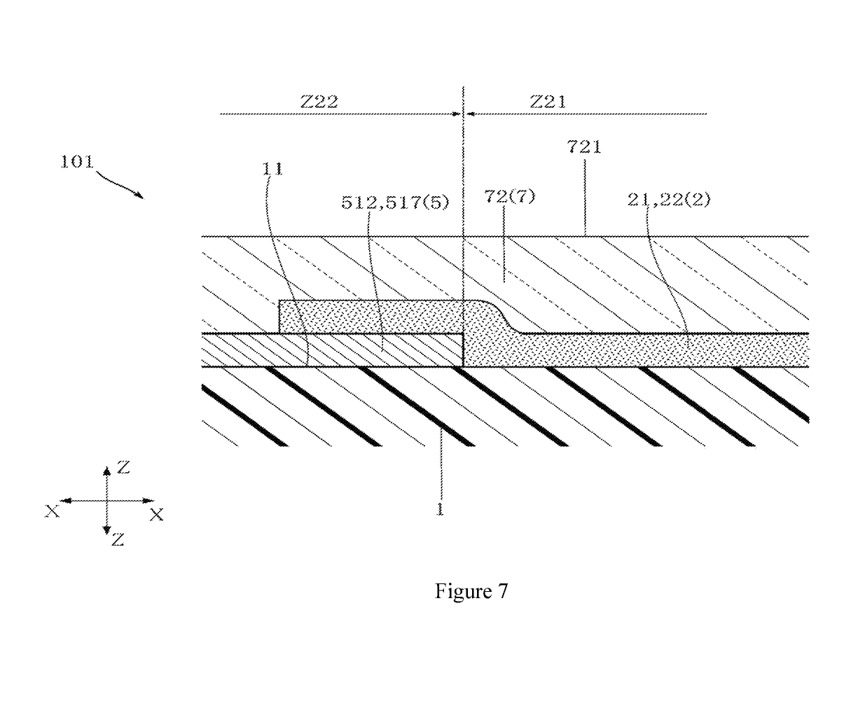

FIG. 2 is a top view showing the heater 101. FIG. 3 is a top view showing a main portion of the heater 101, in which a protection layer 7 is omitted. FIG. 4 is a cross-sectional view along the line IV-IV of FIG. 2. FIG. 5 is an enlarged cross-sectional view showing a main portion of the heater 101. FIG. 6 is an enlarged cross-sectional view showing a main portion of the heater 101. FIG. 7 is a cross-sectional view showing a main portion along the line VII-VII of FIG. 2.

The heater 101 includes a substrate 1, a heat resistor 2, an electrode 5 specified for the resistor, and a protection layer 7.

The substrate 1 is in a longitudinal shape. In FIG. 1 to FIG. 7, a direction of a long side of the substrate 1 is set as a long side direction X, a direction of a short side of the substrate 1 is set as a short side direction Y, and a direction of a thickness of the substrate 1 is set as a thickness direction Z.

In the present embodiment, the substrate 1 includes an insulating material. In the present embodiment, the insulating material constituting the substrate 1 is ceramics. As this ceramics, aluminum oxide and zirconium oxide can be used, for example.

Preferably, a dimension on the thickness direction Z of the substrate 1, i.e. a thickness T, is 0.4˜1.0 mm, for example. More preferably, the thickness of the substrate 1 is 0.4˜0.6 mm, for example. Under the situation that the substrate 1 includes the material with small thermal conductivity (for example, aluminum oxide), the thickness of the substrate 1 is preferably thinner. In addition, a dimension in the short side direction Y of the substrate 1, i.e. a short side direction dimension W, is preferably 3.0˜15.0 mm.

The substrate 1 includes a substrate main surface 11, a substrate back surface 12, a first substrate lateral surface 13, a second substrate lateral surface 14, a first substrate end surface 15 and a second substrate end surface 16. The substrate main surface 11, the substrate back surface 12, the first substrate lateral surface 13, the second substrate lateral surface 14, the first substrate end surface 15 and the second substrate end surface 16 are all flat.

As shown in FIG. 4, the substrate main surface 11 and the substrate back surface 12 are disposed on mutually opposite sides in the thickness direction Z, and facing to mutually opposite sides. The substrate main surface 11 faces to one way of the thickness direction Z. On the other hand, the substrate back surface 12 faces to the other way of the thickness direction Z. The substrate main surface 11 and the substrate back surface 12 are both long rectangular shapes.

The first substrate lateral surface 13, the second substrate lateral surface 14, the first substrate end surface 15 and the second substrate end surface 16 shown in FIG. 2 to FIG. 4 all face to the direction crossing with the thickness direction Z of the substrate 1. The first substrate lateral surface 13 and the second substrate lateral surface 14 are disposed on the plane of the end portion of the substrate 1 in the long side direction.

The heat resistor 2 shown in FIG. 1 to FIG. 7 is formed on the substrate 1. The heat resistor 2 is connected to the substrate 1. In addition, “a certain object formed on another object” recited in the present application includes “the situation that certain object is not connected to another object” in addition to “certain object is connected to other object”. The heat resistor 2 generates heat through flowing current. The heat resistor 2 includes a resistor material. As the resistor material constituting the heat resistor 2, AgPd can be used, for example. As other materials constituting the heat resistor 2, nickel-chromium alloy or ruthenium oxide can be used, for example. The thickness (the dimension in the thickness direction Z) of the heat resistor 2 is, for example 5˜15 nm. The heat resistor 2 is formed by printing, for example. The heat resistor 2 is formed on the side of the substrate main surface 11 in the substrate 1. In the present embodiment, the heat resistor 2 is connected to the substrate main surface 11.

As shown in FIG. 2 to FIG. 4, the heat resistor 2 includes a first elongated portion 21 and a second elongated portion 22.

The first elongated portion 21 extends along the long side direction X of the substrate 1. The first elongated portion 21 is formed in a first short side direction Y1 side (a lower side in FIG. 3) of the short side direction Y of the substrate 1. The first elongated portion 21 is formed from one end of the long side direction X of the substrate 1 to the other end. The length of the first elongated portion 21 is more than 50%, preferably more than 70%, and more preferably more than 80% of the dimension in the long side direction X of the substrate 1. The first elongated portion 21 is connected to the substrate 1, and in the present embodiment, is connected to the substrate main surface 11.

The second elongated portion 22 extends in a longitudinal shape along the long side direction X of the substrate 1. The second elongated portion 22 is formed in a second short side direction Y2 side (an upper side in FIG. 3) of the short side direction Y of the substrate 1. The second elongated portion 22 is formed from one end of the long side direction X of the substrate 1 to the other end. The length of the second elongated portion 22 is more than 50%, preferably more than 70%, and more preferably more than 80% of the dimension in the long side direction X of the substrate 1. The second elongated portion 22 is connected to the substrate 1, and in the present embodiment, is connected to the substrate main surface 11. The second elongated portion 22 and the first elongated portion 21 are separated from each other in the short side direction Y of the substrate 1. The second elongated portion 22 and the first elongated portion 21 are parallel to each other.

As shown in FIG. 4 to FIG. 6, the distance between the first elongated portion 21 and the edge of the substrate 1 in the first short side direction Y1 is a distance L1. In addition, a distance between the second elongated portion 22 and the edge of the substrate in the second short side direction Y2 is a distance L2. Additionally, a distance between the first elongated portion 21 and the second elongated portion 22 in the short side direction Y is a distance L3.

The ratio of the distance Li to the thickness t of the substrate 1 is more than 0 and less than 1.75, and preferably more than 0.05 and less than 1.75. The distance L1 is 0 mm-0.7 mm, and preferably 0.05 mm-0.7 mm. In addition, the ratio of the distance L2 to the thickness t of the substrate 1 is more than 0 and less than 1.75, and preferably more than 0.05 and less than 1.75. The distance L2 is 0 mm-0.7mm, and preferably 0.05 mm-0.7 mm. In addition, the preferred lower limit of the distance L1 and the distance L2 is 0.05 mm since the fabrication of the first elongated portion 21 and the second elongated portion 22 or the protection layer 7 is limited.

The ratio of the distance L3 to the thickness t of the substrate 1 is more than 0 and less than 9.5, and preferably more than 0.05 and less than 9.5. The distance L3 is more than 0 mm and less than 3.8 mm. Preferably, the distance L3 is 0.05 mm-3.8 mm.

The ratio of the distance L1 to the short side direction dimension W is more than 0 and less than 0.23, and preferably more than 0.003 and less than 0.23. The ratio of the distance L2 to the short side direction dimension W is more than 0 and less than 0.23, and preferably more than 0.003 and less than 0.23. The ratio of the distance L3 to the short side direction dimension W is more than 0 and less than 1.27, and preferably more than 0.003 and less than 1.27.

The electrode 5 specified for the resistor shown in FIG. 2 and FIG. 3 is formed on the substrate 1. The electrode 5 specified for the resistor is connected to the substrate 1. The electrode 5 specified for the resistor is used for providing the power outside the heater 101 to the heat resistor 2. The electrode 5 specified for the resistor includes a conductive material. As the conductive material constituting the electrode 5 specified for the resistor, Ag can be used, for example. The thickness (the dimension in the thickness direction Z) of the electrode 5 specified for the resistor is, for example, 5˜15 mm. The electrode 5 specified for the resistor is formed by printing, for example. In the present embodiment, the electrode 5 specified for the resistor is formed at the substrate main surface 11 side in the substrate 1. The electrode 5 specified for the resistor is connected to the substrate main surface 11. As shown in FIG. 4, a part of the electrode 5 specified for the resistor is overlapped with and connected to a part of the heat resistor 2. In the present embodiment, a part of the electrode 5 specified for the resistor is interposed between the heat resistor 2 and the substrate 1. Alternatively, it may be different from the present embodiment that a part of the heat resistor 2 is interposed between the electrode 5 specified for the resistor and the substrate 1.

As shown in FIG. 2 and FIG. 3, the electrode 5 specified for the resistor includes a bond pad 511 for a first resistor, a connecting portion 512 for the first resistor, a bond pad 516 for a second resistor, and a connecting portion 517 for the second resistor.

The bond pad 511 for the first resistor is a rectangular portion. The power from outside of the heater 101 is supplied to the bond pad 511 for the first resistor. The connecting portion 512 for the first resistor is connected to the bond pad 511 for the first resistor. The connecting portion 512 for the first resistor is overlapped with a part of the heat resistor 2, and is connected to the heat resistor 2. More specifically, the connecting portion 512 for the first resistor is overlapped with a first elongated portion 21 in the heat resistor 2, and is connected to the first elongated portion 21 in the heat resistor 2. The connecting portion 512 for the first resistor has a shape of a band extending along the long side direction X of the substrate 1.

The bond pad 516 for the second resistor is a rectangular portion. The connecting portion 517 for the second resistor is connected to the bond pad 516 for the second resistor. The connecting portion 517 for the second resistor is overlapped with a part of the heat resistor 2, and is connected to the heat resistor 2. More specifically, the connecting portion 517 for the second resistor is overlapped with a second elongated portion 22 in the heat resistor 2, and is connected to the second elongated portion 22 in the heat resistor 2. The connecting portion 517 for the second resistor has a shape of a band extending along the long side direction X of the substrate 1. Along the short side direction Y of the substrate 1, the connecting portion 517 of the second resistor is separated from the bond pad 516 of the second resistor.

In addition, a coupling portion 59 is formed on the heater 101 for coupling the first elongated portion 21 and the second elongated portion 22. The coupling portion 59 extends along the short side direction Y of the substrate 1. One end of the first elongated portion 21 is coupled with one end of the second elongated portion 22 by the coupling portion 59. The coupling portion is connected to both the first elongated portion 21 and the second elongated portion 22. The coupling portion 59 and bond pad 511 for the first resistor are formed on opposite sides of the heat resistor 2.

As shown in FIG. 2, FIG. 3 and FIG. 7, the substrate 1 includes a heating zone Z21 and a non-heating zone Z22.

The heating zone Z21 is in the long side direction X of the substrate 1. The heating zone Z21 is also a zone between the heat resistor 2 and the electrode 5, and overlapped with the heat resistor 2. In the present embodiment, as shown in FIG. 4, an end of the connecting portion 512 for the first resistor is coincident with the boundary between the heat-generating zone Z21 and the non-heat-generating zone Z22. Similarly, an end of the connecting portion 517 for the second resistor is coincident with the boundary between the heat-generating zone Z21 and the non-heat-generating zone Z22.

The non-heating zone Z22 is a different zone from the heating zone Z21. The non-heating zone Z22 is adjacent to the heating zone Z21 in the long side direction X. In the present embodiment, the bond pad 511 for the first resistor, the connecting portion 512 for the first resistor, the bond pad 516 for the second resistor and the connecting portion 517 for the second resistor are disposed in the non-heating zone Z22.

The protection layer 7 shown in FIG. 1, FIG. 2, and FIG. 4 to FIG. 7 covers the heat resistor 2. In addition, the protection layer 7 is adjacent to the heat resistor 2. Further, the protection layer 7 covers a portion of the electrode 5. Specifically, the protection layer 7 covers the connecting portion 512 of the first resistor and the connecting portion 517 of the second resistor. The electrode 5 for the resistor is partially exposed from the protection layer 7. Specifically, the bond pad 511 for the first resistor and the bond pad 516 for the second resistor are exposed from the protection layer 7. The protection layer 7 includes, for example, glass or polyimide, etc.

As shown in FIG. 1, in the device 800, the substrate main surface 11 side of the substrate 1 is toward the platen roller 801. Therefore, the heat resistor 2 is disposed between the substrate 1 and the platen roller 801. On the other hand, a thermistor 861 is arranged on the substrate back surface 12 for detecting a temperature of the substrate 1.

Subsequently, the effects of the heater 101 are illustrated.

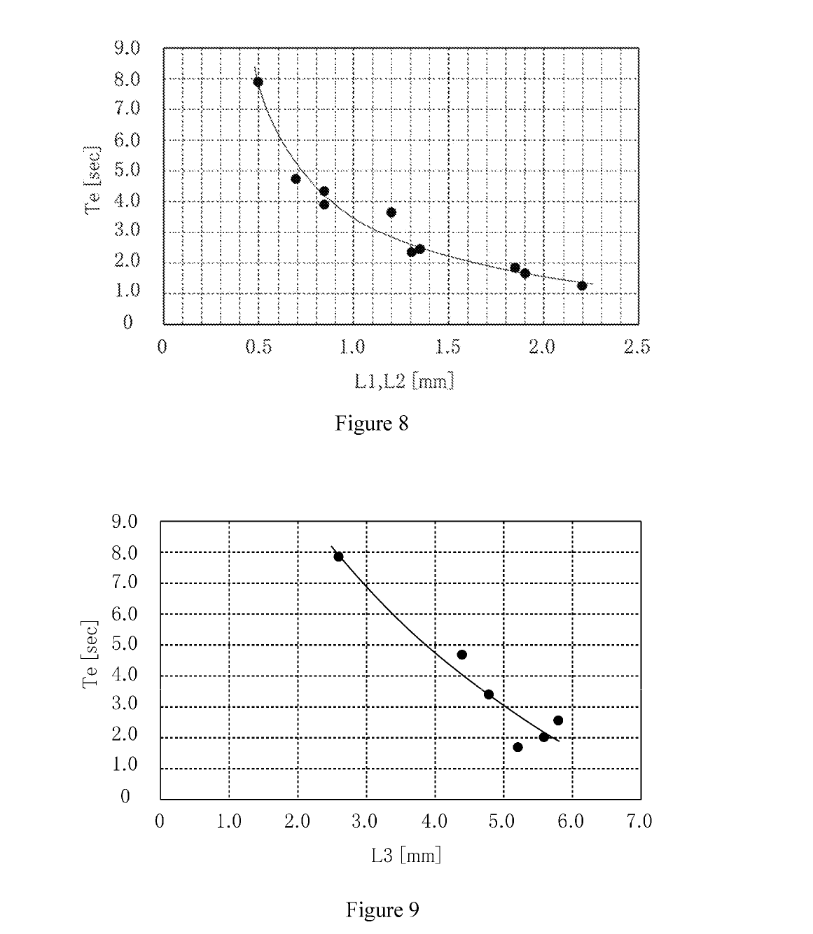

FIG. 8 shows the relationship between the dimension of distance L1 and distance L2 and the endurance time Te. At this time, the substrate 1 includes aluminum oxide or zirconium oxide, and the thickness t is set as 0.4 mm˜1.0 mm. The endurance time Te is defined as while a power energy is applied to the heater 101, the time till the substrate 1 or the heat resistor 2 is confirmed as failed. Such test is performed under a situation that the applied power energy is relatively large, for example, being about 1823 W.

As shown in FIG. 8, while distance L1 and distance L2 are more than 0.7 mm, the endurance time Te is approximately less than 4.5 sec. On the other hand, while distance L1 and distance L2 are less than 0.7 mm, the endurance time Te is approximately more than 4.5 sec. Additionally, while distance L1 and distance L2 are less than 0.7 mm, when the distance L1 and the distance L2 are reduced, the degree of increase of the endurance time Te is more than the degree that while distance L1 and the distance L2 are more than 0.7 mm. As a result, if the distance L1 and the distance L2 are less than 0.7 mm, failures of the substrate 1 or the heat resistor 2 can be prohibited. In addition, while the ratio of the distance L1 and the distance L2 to the thickness t of the substrate 1 is less than 1.75, the effect of prohibiting failures is achieved.

Additionally, in the test shown in FIG. 8, the short side direction dimension W of the substrate 1 is 3 mm˜15 mm. Accordingly, under the situation that the ratio of the distance L1 and the distance L2 to the short side direction dimension W is less than 0.23, the effect of prohibiting failures is achieved.

If the distance L1 and the distance L2 are set to be more than 0.05 mm, unreasonable difficulties during fabrication of the first elongated portion 21 and the second elongated portion 22 or the protection layer 7 can be prevented. If taking this into consideration, the ratio of the distance L1 and the distance L2 to the thickness t is preferably more than 0.05 and less than 1.75. In addition, the ratio of the distance L1 and the distance L2 to the short side direction dimension W is preferably more than 0.003 and less than 0.23.

FIG. 9 shows the relationship between the dimension of distance L3 and the endurance time Te. At this time, the substrate 1 includes aluminum oxide or zirconium oxide, and the thickness t is set as 0.4 mm˜1.0 mm. The endurance time Te is the same as that in FIG. 8.

As shown in FIG. 9, while distance L3 is more than 3.8 mm, the endurance time Te is approximately less than 5.0 sec. On the other hand, while distance L3 is less than 3.8 mm, the endurance time Te is approximately more than 5.0 sec. Accordingly, if the distance L3 is less than 3.8 mm, failures of the substrate 1 or the heat resistor 2 can be prohibited. In addition, while the ratio of the distance L1 and the distance L2 to the thickness t of the substrate 1 is less than 9.5, the effect of prohibiting failures can be achieved. Taking 0.05 mm as the lower limit of the distance L3 into consideration, the ratio of the distance L1 and the distance L2 to the thickness t of the substrate 1 is preferably more than 0.05 and less than 9.5.

In addition, in the test result shown in FIG. 9, the short side direction dimension W of the substrate 1 is 3 mm˜15 mm. Therefore, under the situation that the ratio of the distance L3 to the short side direction dimension W is more than 0 and less than 1.27, the effect of preventing damages on the substrate 1 and the heat resistor 2. Taking 0.05 mm as the lower limit of the distance L3 into consideration, the ratio of the distance L3 to the short side direction dimension W of the substrate 1 is preferably more than 0.003 and less than 1.27.

As the material of the substrate 1, aluminum oxide or zirconium oxide is used, such that the cost of the heater 101 can be reduced.

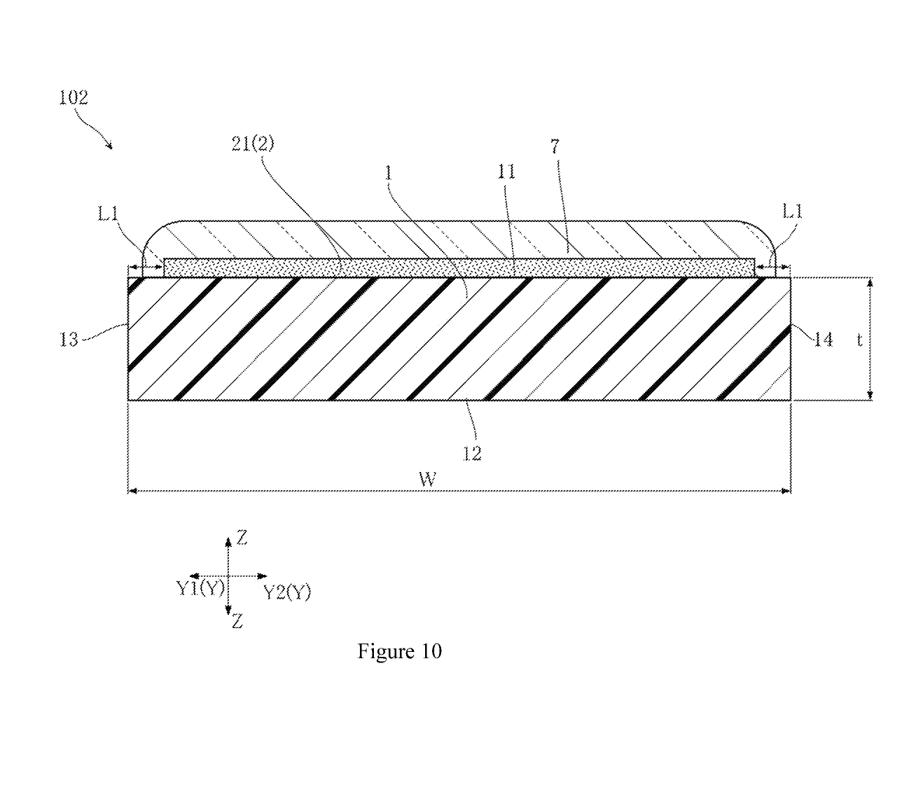

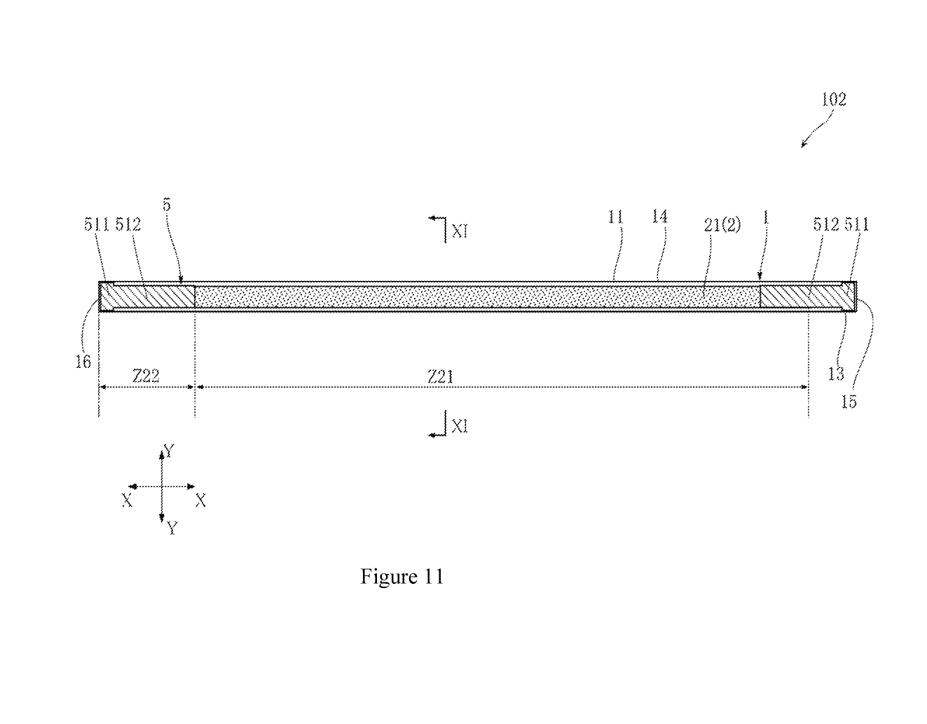

FIG. 10 and FIG. 11 show another embodiment of the present invention. In addition, in these figures, implementations or elements the same as or similar to those in the above embodiments are indicated by the same reference numerals.

FIG. 10 and FIG. 11 show a heater according to the second embodiment of the present invention. The difference between the heater 102 of the present embodiment and the heater 101 mentioned above is that the heat resistor 2 is only includes a first elongated portion 21.

FIG. 10 is a top view showing a main portion of the heater 102, and the protection layer 7 is omitted. FIG. 11 is a cross-sectional view along line XI-XI in FIG. 10.

The first elongated portion 21 extends in a longitudinal shape along the long side direction X of the substrate 1. In the present embodiment, as shown in FIG. 11, the distances between two lateral ends in the short side direction Y of the first elongated portion 21 and two edges in the short side direction Y of the substrate 1 are respectively distance L1.

In the present embodiment, a ratio of the distance L1 to the thickness t of the substrate 1 is also more than 0 and less than 1.75, and preferably more than 0.05 and less than 1.75. The distance L1 is 0 mm˜0.7 mm, and preferably 0.05mm˜0.7mm. In addition, the ratio of the distance L1 to the short side direction dimension W is more than 0 and less than 0.23, and preferably more than 0.003 and less than 0.23. In addition, owing to the limit to fabricate the first elongated portion 21 or the protection layer 7, the lower limit of the distance L1 is preferably 0.05 mm.

An electrode 5 for a resistor in the present embodiment includes a pair of bond pads 511 for a first resistor and a pair of connecting portions 512 for the first resistor. The pair of bond pads 511 for the first resistor are formed on a substrate main surface 11 of a substrate 1, and arranged laterally at two sides of the substrate 1 in the long side direction X. The connecting portions 512 pair for the first resistor connects the pair of bond pads 511 for the first resistor with two ends of the first elongated portion 21 (the heat resistor 2) in the long side direction X.

According to this embodiment, failures of the substrate 1 or the heat resistor 2 can also be prohibited.

The heater of the present invention is not limited to the above embodiments. The specific constitution of each part of the heater in the present invention can be freely designed and varied.

What is claimed is:

1. A heater, comprising:
a substrate in a longitudinal shape;
a heat resistor, formed on the substrate; and
an electrode for resistor, formed on the substrate and in contact with the heat resistor;
wherein the heat resistor includes a first elongated portion, and the first elongated portion extends along a long side direction of the substrate and is disposed in a side in a first short side direction, which is one of short side directions of the substrate, and
wherein a ratio of a distance between the first elongated portion and an edge of the substrate in the first short side direction, to a thickness of the substrate is more than 0 and less than 1.75.

2. The heater according to claim 1, wherein the ratio of the distance between the first elongated portion and the edge of the substrate in the first short side direction, to the thickness of the substrate is more than 0.05 and less than 1.75.

3. The heater according to claim 1, wherein the heat resistor further comprises a second elongated portion, the second elongated portion extends along the long side direction of the substrate and is disposed in a side in a second short side direction, which is opposite to the first short side direction;
the first elongated portion and the second elongated portion are separated in a short side direction of the substrate,
a ratio of a distance between the second elongated portion and an edge of the substrate in the second short side direction, to the thickness of the substrate is more than 0 and less than 1.75.

4. The heater according to claim 3, wherein the ratio of the distance between the second elongated portion and the edge of the substrate in the second short side direction, to the thickness of the substrate is more than 0.05 and less than 1.75.

5. The heater according to claim 3, wherein the distance between the first elongated portion and the edge in the substrate on the first short side direction is 0 mm˜0.7 mm.

6. The heater according to claim 5, wherein the distance between the first elongated portion and the edge of the substrate in the first short side direction is 0.05 mm˜0.7 mm.

7. The heater according to claim 3, wherein the distance between the second elongated portion and the edge of the substrate in the second short side direction is 0 mm˜0.7 mm.

8. The heater according to claim 7, wherein the distance between the second elongated portion and the edge of the substrate in the second short side direction is 0.05 mm˜0.7 mm.

9. The heater according to claim 3, wherein a ratio of a distance between the first elongated portion and the second elongated portion in the short side direction, to the thickness of the substrate is more than 0 and less than 9.5.

10. The heater according to claim 9, wherein the ratio of the distance between the first elongated portion and the second elongated portion in the short side direction, to the thickness of the substrate is more than 0.05 and less than 9.5.

11. The heater according to claim 9, wherein the distance between the first elongated portion and the second elongated portion in the short side direction is more than 0 mm and less than 3.8 mm.

12. The heater according to claim 11, wherein the distance between the first elongated portion and the second elongated portion in the short side direction is more than 0.05 mm and less than 3.8 mm.

13. The heater according to claim 3, wherein the thickness of the substrate is 0.4˜1.0 mm.

14. The heater according to claim 3, wherein a ratio of the distance between the first elongated portion and the edge of the substrate in the first short side direction, to a dimension of the substrate in the short side direction is more than 0 and less than 0.23.

15. The heater according to claim 14, wherein the ratio of the distance between the first elongated portion and the edge of the substrate in the first short side direction, to the dimension of the substrate in the short side direction is more than 0.003 and less than 0.23.

16. The heater according to claim 14, wherein a ratio of the distance between the second elongated portion and the edge of the substrate in the second short side direction, to the dimension of the substrate on the short side direction is more than 0 and less than 0.23.

17. The heater according to claim 16, wherein the ratio of the distance between the second elongated portion and the edge of the substrate in the second short side direction, to the dimension of the substrate on the short side direction is more than 0.003 and less than 0.23.

18. The heater according to claim 14, wherein a ratio of a distance between the first elongated portion and the second elongated portion in the short side direction, to the dimension of the substrate in the short side direction is more than 0 and less than 1.27.

19. The heater according to claim 18, wherein the ratio of the distance between the first elongated portion and the second elongated portion in the short side direction, to the dimension of the substrate in the short side direction is more than 0.03 and less than 1.27.

20. The heater according to claim 14, wherein dimension of the substrate in the short side direction is 3.0 mm˜15.0 mm.

21. The heater according to claim 3, wherein the substrate includes aluminum oxide or zirconium oxide.

22. The heater according to claim 3, further comprising a protection layer covering the heat resistor.

23. The heater according to claim 22, wherein the protection layer covers the first elongated portion, the second elongated portion and at least a portion of the electrode.

24. The heater according to claim 23, wherein the electrode includes a bond pad for a first resistor and a bond pad for a second resistor,
wherein the bond pad for the first resistor and the bond pad for the second resistor are exposed from the protection layer.

25. The heater according to claim 24, wherein the electrode includes a connecting portion for the first resistor and a connecting portion for the second resistor,
the connecting portion for the first resistor is connected to the bond pad for the first resistor and in contact with the first elongated portion,
the connecting portion for the second resistor is connected to the bond pad for the second resistor and in contact with the second elongated portion,
the connecting portion for the first resistor and the connecting portion for the second resistor are covered by the protection layer.

26. The heater according to claim 22, wherein the protection layer includes glass.

27. The heater according to claim 1, wherein the heat resistor includes AgPd, nickel-chromium alloy, or ruthenium oxide.
